(19) United States
(12) Patent Application Publication
(10) Pub. No.: US 2026/0144615 A1
(43) Pub. Date: May 28, 2026

(54) MINIMALLY INVASIVE ORTHO-RESTORATIVE TREATMENT PLANNING

(71) Applicant: Align Technology, Inc., San Jose, CA (US)

(72) Inventors: Vladislav Andreevich MIRYAHA, Moscow (RU); Olga MATUSEVICH, Moscow (RU); Polina ANTYASOVA, Yerevan (AM); Alexander KULINICH, Nizhegorodskaya (RU); Elena AGILINA, Holmdel, NJ (US); Boris Aleksandrovich VYSOKANOV, Moscow (RU); Dmitry Yurievich CHEKH, Moscow (RU)

(21) Appl. No.: 19/402,317

(22) Filed: Nov. 26, 2025

Related U.S. Application Data
(60) Provisional application No. 63/725,510, filed on Nov. 26, 2024.

(51) Int. Cl. A61C 7/00; A61C 13/00; G06F 30/00; G06T 7/00

(52) U.S. Cl. CPC A61C 7/002; A61C 13/0004; G06F 30/00; G06T 7/0014; G06T 2207/30036

(57) ABSTRACT

Systems and methods for minimally invasive ortho-restorative treatment planning. One or more clinical and/or aesthetic aspects of an ortho-restorative treatment plan may be optimized. In some examples, the ortho-restorative treatment plan is optimized to minimize a tooth mass loss associated with adding or implementing a restorative feature in the ortho-restorative treatment plan. Examples of restorative features may include crowns, veneers, fillings, inlays, onlays, edge bonding, composites, implants, bridges and prosthetics. The methods may include computer modeling techniques. For example, a position of a digital restorative feature model may be optimized with respect to a digital tooth model of a patient's teeth to minimized tooth mass loss in the patient's teeth.

### CLAIM OF PRIORITY

This patent application claims priority to U.S. provisional patent application No. 63/725,510, filed on Nov. 26, 2024, and titled “MINIMALLY INVASIVE ORTHO-RESTORATIVE TREATMENT PLANNING.” This patent application is herein incorporated by reference in its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### FIELD

Minimally invasive restorative and ortho-restorative treatment planning, including optimizing aspects related to positioning restorative devices on a patient's teeth. Techniques may include minimizing tooth material loss during treatment.

### BACKGROUND

Restorative dentistry focuses on diagnosing, preventing, and/or treating oral diseases, with the goal of restoring the function, integrity, and appearance of damaged or missing teeth. The aim goal of restorative dentistry is generally to restore the health and function of teeth. Examples of restorative devices may include crowns, veneers, fillings, inlays and onlays (which are typically used to repair damaged teeth) and implants and bridges (which are typically used to replace missing or damaged teeth). Ortho-restorative dentistry combines aspects of restorative dentistry with orthodontics (correcting misaligned teeth and/or jaws). In general, ortho-restorative treatments aim to improve both the function and aesthetic of the teeth. For example, a patient's teeth may not only be misaligned but need structural repair or enhancement.

One of the problems in restorative and ortho-restorative dentistry relates to the need to remove a portion of a patient's tooth in order to bond or implant a restorative device. For example, a portion of the tooth may be ground down to accommodate the restorative device. This may mean removing some or all the natural anatomical features of a tooth, which may otherwise serve important roles in the function and health of the teeth. For example, tubercles, which are small, rounded projections or bumps that may exist on crowns of teeth, may aid in chewing and grinding of food. Fissures, which are narrow grooves or crevices typically found on occlusal surfaces of molars and premolars, may help guide teeth in their proper bite position. Minimizing the amount of tooth removal may preserve at least some of these anatomical features as well as help maintain the structural integrity of the tooth.

It would be useful to have ways of minimizing or reducing tooth loss during restorative and ortho-restorative treatments. It would also be useful to have ways of optimizing other aspects related to restorative and ortho-restorative treatments.

### SUMMARY OF THE DISCLOSURE

Described herein are apparatuses (e.g., devices, systems and/or appliances) and methods of minimally invasive restorative and ortho-restorative treatment planning. Computer modeling techniques may be used to determine one or more aspects of an ortho-restorative treatment plan related to one or more restorative features (e.g., crowns, veneers, fillings, implants) used in ortho-restorative treatment plan. For example, a distance between a restorative feature model and a tooth model of a patient's teeth in a target arrangement may be optimized to minimize tooth loss mass associated with implementing the restorative feature.

In some aspects, a computer-implemented method of ortho-restorative treatment planning includes: accessing an initial tooth model representing an initial tooth arrangement of a patient's teeth; generating an ortho-restorative treatment plan for moving the patient's teeth from the initial tooth arrangement toward the target tooth arrangement via a series of intermediate tooth arrangements, wherein the target tooth arrangement includes a change in mass of at least one tooth of the patient's teeth associated with a restorative feature, wherein generating the ortho-restorative treatment plan includes optimizing a relative position of a restorative feature model and a tooth model of the at least one tooth in the target tooth arrangement to minimize a tooth mass loss of the at least one tooth associated with the restorative feature; and generating instructions to output a visualization showing the tooth mass loss of the at least one tooth associated with the restorative feature.

The ortho-restorative treatment plan may include multiple restorative features, wherein generating the ortho-restorative treatment plan includes optimizing relative positions of multiple restorative feature models and the tooth model of the at least one tooth. Generating the ortho-restorative treatment plan may further include optimizing a size of the restorative feature model relative to the tooth model of the at least one tooth to minimize the tooth mass loss of the at least one tooth associated with the restorative feature.

Minimizing the tooth mass loss may be one of multiple clinical and/or aesthetic goals that are optimized, wherein the multiple clinical and/or aesthetic goals further includes one or more of: minimizing a tooth mass loss of specific one or more teeth of the patient's teeth; minimizing a duration of the ortho-restorative treatment plan; minimizing breaching of dentin of the one or more teeth; minimizing a number of dental attachments used in the ortho-restorative treatment plan; achieving a desired smile line; achieving a desired amount of the patient's gums showing in a smile; achieving a desired height of a bite of the patient's teeth; achieving a maximum orthodontic grade; minimizing a discrepancy between a centric occlusion (CO) and/or a centric relation (CR) of the patient's mandible; achieving a desired amount of bite contact; achieving a desired amount of vertical force between the patient's upper and lower jaws; considering the presence of one or more implants; considering a material of the restorative feature; considering different materials of the restorative feature on different teeth of patient; considering the use of a pre-less restorative feature; achieving a stable arch of the patient; generating enough bone for an implant; considering a position of one or more nerves; maximizing gingival preservation; considering any discrepancies between the patient's upper and lower arches.

Optimizing the relative position of the restorative feature model and the tooth model of the at least one tooth may include: identifying a portion of the tooth model of the at least one tooth that resides outside of the restorative feature model; determining a volume of the portion of the tooth model of the at least one tooth that resides outside of the restorative feature model, wherein the volume corresponds to a volume of the tooth mass loss; and iteratively adjusting a position the restorative feature model and/or the tooth model until the volume is minimized. The position the restorative feature model and/or the tooth model may be iteratively adjusted based on a penalty function.

The tooth model may be represented by a number of tooth points that is less than a plurality of points defining an entire mesh of the tooth model. Locations of the number of tooth points on the tooth model may be based on an intended location of the restorative feature model on the tooth model.

Minimizing the tooth mass loss may include: determining a shape overlap value between the restorative feature model and the tooth model, wherein the shape overlap value is a squared distance between the plurality of tooth points and the restorative feature model; and adjusting the relative position so that the shape overlap value tends to zero.

The restorative feature model may be represented by a number of restorative points, wherein the plurality of restorative points are determined by decimating a mesh of the restorative feature model and identifying center points of each polygon of the decimated mesh, wherein the number of restorative points corresponds to the center points of the polygons of decimated mesh. Methods may include assigning weights to the number of restorative points; calculating distances between the plurality of restorative points and the tooth model; penalizing each restorative point of the plurality of restorative points that are inside the tooth model; and calculating a weighted sum of the penalized restorative points.

At least one intermediate tooth arrangement of the series of intermediate tooth arrangements may include an intermediate restorative feature model, wherein generating the ortho-restorative treatment plan may include optimizing a relative position of the intermediate restorative feature model and a tooth model in the at least one intermediate tooth arrangement. Optimizing the relative position of the restorative feature model and the tooth model of the at least one tooth may include moving the restorative feature model and/or moving the tooth model.

Visualization may include an overlap view showing an overlap of the restorative feature model and the tooth model indicating a location of the tooth loss mass.

According to some aspects, a system for ortho-restorative treatment planning includes: one or more processors; and one or more memory stores coupled to one or more processors, the one or more memory stores configured to store computer instructions that, when executed by the one or more processors, perform a computer-implemented method including: accessing an initial tooth model representing an initial tooth arrangement of a patient's teeth; generating an ortho-restorative treatment plan for moving the patient's teeth from the initial tooth arrangement toward the target tooth arrangement via a series of intermediate tooth arrangements, wherein the target tooth arrangement includes a change in mass of at least one tooth of the patient's teeth associated with a restorative feature, wherein generating the ortho-restorative treatment plan includes optimizing a relative position of a restorative feature model and a tooth model of the at least one tooth in the target tooth arrangement to minimize a tooth mass loss of the at least one tooth associated with the restorative feature; and generating instructions to output a visualization showing the tooth mass loss of the at least one tooth associated with the restorative feature.

According to some aspects, a computer system is configured to generate a user interface, wherein the user interface is configured to: display aspects of an ortho-restorative treatment plan for moving a patient's teeth from an initial tooth arrangement toward a target tooth arrangement via a series of intermediate tooth arrangements, wherein the target tooth arrangement includes a change in mass of at least one tooth of the patient's teeth associated with a restorative feature; and display an overlap view of a restorative feature model and a tooth model of the at least one tooth in the target tooth arrangement, wherein the restorative feature model has an optimized position relative to the tooth model that minimizes a tooth mass loss of the at least one tooth associated with the restorative feature. The user interface may further be configured to provide one or more controls that allow the user to adjust the optimized position of the restorative feature.

All of the methods and apparatuses described herein, in any combination, are herein contemplated and can be used to achieve the benefits as described herein.

These and other aspects and details are described herein.

### BRIEF DESCRIPTION OF THE DRAWINGS

Novel features of embodiments described herein are set forth with particularity in the appended claims. A better understanding of the features and advantages of the embodiments may be obtained by reference to the following detailed description that sets forth illustrative embodiments and the accompanying drawings.

FIG. 1 is a flowchart indicating an example process for generating an ortho-restorative treatment plan that includes optimizing aspects of a restorative feature based on achieving one or more clinical goals and/or one or more aesthetic goals.

FIG. 2A illustrates an example digital model showing overlap of a restorative feature with a dentition in a final tooth arrangement, where the position of the restorative feature is not optimized to minimize tooth mass loss.

FIG. 2B illustrates an example digital model showing overlap of a restorative feature with the dentition of FIG. 2A, where the position of the restorative feature is optimized to minimize tooth mass loss.

FIG. 3A illustrates an example tooth model having tooth points, which represent the shape of a portion of the tooth model, are used to determine overlap between the tooth model and a restorative feature model.

FIG. 3B illustrates an example table showing example overlap values for several teeth of a dentition model and restorative feature.

FIG. 3C illustrates an example of overlap between a restorative feature model and a tooth model, where the tooth model is represented by tooth points.

FIG. 3D illustrates an example of a tooth model showing an overlap region where a restorative feature overlaps with the tooth model.

FIG. 4 is a flowchart indicating an example process for minimizing tooth loss reduction using representative tooth points for a tooth model.

FIGS. 5A and 5B illustrate an example tooth model and a restorative feature model, where the restorative feature model includes restorative points that are used to determine overlap between the tooth model and the restorative feature model.

FIG. 5C is a flowchart indicating an example process for determining overlap between a restorative feature and a tooth model represented by restorative points.

FIG. 5D illustrates an example of a capsule used to approximate distances between restorative points of a restorative feature model and a tooth model.

FIGS. 5E and 5F illustrate different views of an example tooth model of an upper central tooth with areas of overlap with a restorative feature model.

FIGS. 5G and 5H illustrate different views of an example tooth model of an incisor tooth with areas of overlap with a restorative feature model.

FIG. 6 illustrates an example block diagram of a computing environment for generating an ortho-restorative treatment plan.

FIG. 7 illustrates an example block diagram of an ortho-restorative treatment planning module for optimizing aspects related to one or more restorative features used in an ortho-restorative treatment plan.

FIG. 8 is a flowchart indicating an example interactive user interface process for presenting one or more ortho-restorative treatment plans.

FIGS. 9A-9I illustrate examples views of an interactive user interface for presenting aspects of one or more ortho-restorative treatment plans.

### DETAILED DESCRIPTION

The apparatuses and methods described herein are configured to incorporate clinical and/or aesthetic considerations related to restorative features (e.g., crowns, veneers, fillings, implants) in ortho-restorative treatment plans. In some examples, the techniques involve treatment planning that minimizes tooth loss associated with the restorative treatment. Techniques may involve computer modeling, where a tooth model represents one or more teeth, and one or more restorative feature models represent one or more restorative features. The relative positions of the tooth model and the restorative feature model(s) may be optimized to achieve clinical and/or aesthetic goal(s), such as minimizing tooth loss.

The apparatuses and methods described herein may be used in ortho-restorative treatment. Ortho-restorative treatments generally involve the use of restorative features (also referred to as restorations or restoratives) such as crowns, veneers, fillings, inlays, onlays, edge bonding, composites, implants, bridges and prosthetics. The restorative features may be applied to one or more teeth to restore function, appearance or health of the teeth and/or supporting structures. Ortho-restorative treatments combine aspects of restorative treatment with aspects of orthodontics. For example, ortho-restorative treatments may include the use of one or more restorative features as well as correcting misaligned teeth and/or jaws. In some cases, ortho-restorative treatments include the use of a series of removable dental appliances (e.g., aligners, palatal expanders) that are configured to incrementally adjust the position of one or more of a patient's teeth from an initial tooth arrangement (e.g., before treatment) toward a target (e.g., desired, final) tooth arrangement. The ortho-restorative treatments may include intermediate stages, with each stage involving an incremental movement of one or more teeth implemented by a corresponding removable dental appliance until the target tooth arrangement is achieved. The restorative treatments may be implemented during predetermined stages of the orthodontic treatment plan and/or after completion of the orthodontic treatment. For instance, different intermediate stages of a treatment plan may involve the use of restorative features having different shapes and/or sizes. One or more final restorative features may be applied to the patient's teeth after treatment is completed (e.g., when the patient's teeth have achieved a final arrangement).

Ortho-restorative treatments may have some advantages over only restorative and only orthodontic treatments. For example, ortho-restorative treatments may be less invasive than restorative-only treatments because orthodontic repositioning of the teeth may decrease the amount of tooth mass loss required to achieve the treatment target. Additionally, ortho-restorative treatments may be faster than orthodontics only treatments since modifying the patient's tooth mass may reduce the extent of orthodontic repositioning needed to achieve the treatment target.

Any of the apparatuses and methods described herein may involve computer modeling. For example, a patient's dentition may be represented as one or more digital (virtual) dental models that are manipulatable, for example, by a computer program and/or user input. For example, in orthodontic and ortho-restorative treatment planning, an initial tooth/dentition model may represent an initial tooth arrangement of a patient's teeth, a final or target tooth/dental model may represent a final or target tooth arrangement of the patient's teeth, and one or more intermediate tooth/dentition models may represent corresponding one or more intermediate tooth arrangements of a patient's teeth. In some cases, the computer models may be rendered on one or more user interfaces of one or more computers.

The computer-based methods and systems described herein may consider the shape of one or more restorative features and/or the shape of one or more teeth (and/or the shape of one or more other anatomical or non-anatomical features). For example, teeth and restorative features may be represented as objects in digital three-dimensional (3D) space. In digital 3D space, a “shape” of an object may generally refer to its geometric form or external boundary. For example, the shape of an object may be defined by a set of points (e.g., vertices) that create a mesh of polygons that define the geometric form or external boundary of the object. The shape of an object may determine its dimensions and contours. The digital (e.g., 3D) models may or may not be represented visually using computer graphics. For example, the digital models may be presented on a computer display.

Computer modeling may also be used to create digital models of dental appliances (e.g., aligners, palatal expanders). The shape of a dental appliance model may at least partially depend on one or more dentition models of a patient's teeth. For example, a dental appliance model may include cavities that are configured to accept the teeth of a dentition model. In cases where orthodontic treatment is involved, the dental appliance model may be shaped to apply force(s) on the one or more teeth of the dentition model. For example, walls of one or more of the cavities may be offset by a predetermined amount such that the walls can apply a predetermined force (e.g., in a predetermined direction and/or magnitude) on one or more of the teeth of the dentition model. In some cases, a computer program is configured to simulate forces applied by the dental appliance model on the dentition model. The dental appliance models may be used (either directly or indirectly) to determine the shapes and sizes of corresponding physical dental appliances.

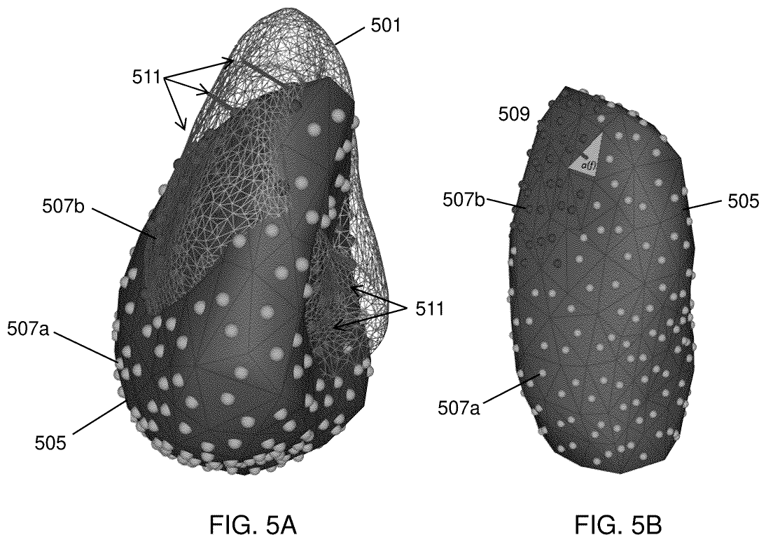

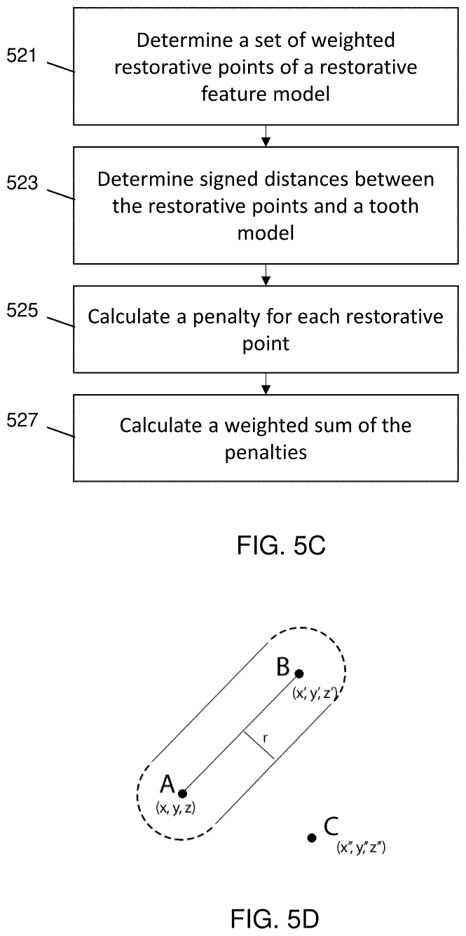

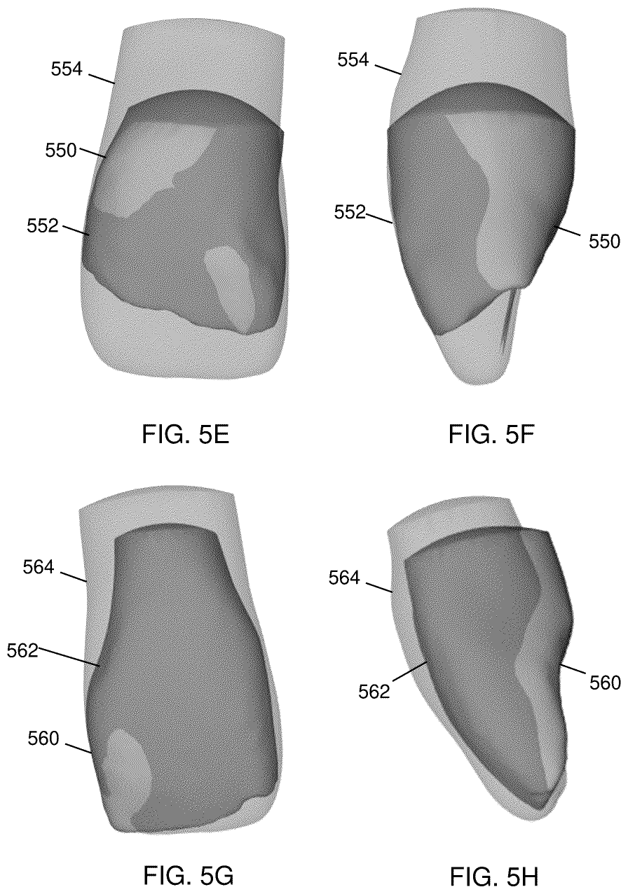

Any of the digital 3D shapes described herein may be represented with capsules, such as the capsule shown in FIG. 5D. For example, surfaces of a tooth model and/or restorative feature model may be filled with capsules. A capsule may be elongated and rounded to have semi-spherical ends. The capsule can have a core that is a line segment extending a length of the capsule, and an outer 3D surface surrounding and extending from the core by a set radius, r. These capsules may be useful for calculating distances between objects.

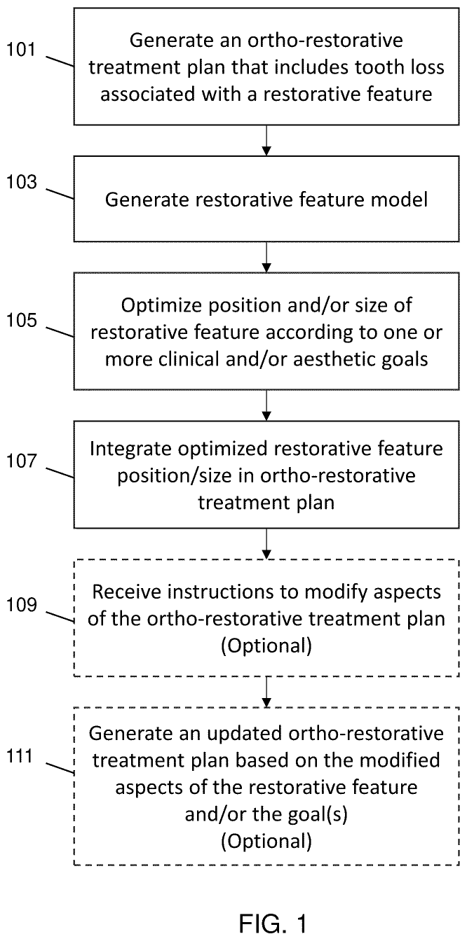

FIG. 1 shows a flowchart indicating an example process for generating an ortho-restorative treatment plan. At 101, an ortho-restorative treatment plan that includes tooth loss in one or more teeth associated with a restorative feature is generated. The ortho-restorative treatment plan may involve movement of one or more teeth of a dentition from an initial tooth arrangement toward a target (e.g., final or desired) tooth arrangement (e.g., as a goal after the treatment is complete) via a series of intermediate tooth arrangements. The initial tooth arrangement may be input that may be based, for example, from one or more images of a scan of a patient's oral cavity (e.g., using a dental scanner). The ortho-restorative treatment plan may include a target tooth model that corresponding to a digital model of the target tooth arrangement of the patient's teeth, and a series of intermediate tooth models corresponding to the intermediate tooth arrangements.

At 103, a restorative feature model is generated. The restorative feature model may correspond to a digital model of a restorative feature that is to be used in the ortho-restorative treatment plan. For example, the restorative feature may correspond to a crown, veneer, filling, inlay, onlay, edge bonding, composite, implant, bridge, prosthetic, or any combination of thereof. The restorative feature model may have an approximate shape (e.g., topology) and size for covering or replacing a volume of tooth loss of the one or more teeth associated with the restorative feature. The shape and size of the restorative feature may be approximated based on achieving aesthetic and/or clinical outcomes of the teeth in the target arrangement and/or in one or more intermediate tooth arrangements. For example, the shape and size of a restorative feature may be determined based on providing desired final tooth shapes, dental arch symmetry and bite (e.g., Class I bite) when the teeth are in the target tooth arrangement. If multiple restorative features are used, corresponding models of the multiple restorative features may be generated. The presence of the restorative feature may mean moving the teeth to positions that may not be desirable in the absence of the restorative feature. For example, spaces between teeth may be planned to provide room for the restorative feature, which would not be planned if no restorative feature were used. In any of these methods and apparatuses, generating the ortho-restorative treatment plan may include optimizing a volume of the restorative feature model (and/or the tooth model). The volume of the restorative feature model may optimized as described herein.

At 105, relative positions of the restorative feature and the teeth, and/or the size of the restorative feature, are optimized according to one or more clinical and/or aesthetic goals. Examples of clinical and/or aesthetic goals may include minimizing the tooth mass loss/reduction of the one or more teeth, minimizing a tooth mass loss of specific one or more teeth of the patient's teeth, minimizing a duration of the ortho-restorative treatment plan, minimizing breaching of dentin of the one or more teeth, minimizing a number of dental attachments used in the ortho-restorative treatment plan, achieving a desired smile line, achieving a desired amount of the patient's gums showing in a smile, achieving a desired height of a bite of the patient's teeth, achieving a maximum orthodontic grade, minimizing a discrepancy between a centric occlusion (CO) and/or a centric relation (CR) of the patient's mandible, achieving a desired amount of bite contact, achieving a desired amount of vertical force between the patient's upper and lower jaws, considering the presence of one or more implants, considering a material of the restorative feature, considering different materials of the restorative feature on different teeth of patient, considering the use of a pre-less restorative feature, achieving a stable arch of the patient, generating enough bone for an implant, considering a position of one or more nerves, maximizing gingival preservation and/or considering any discrepancies between the patient's upper and lower arches.

In some cases, the restorative feature optimizing algorithm is implemented on a target (final) tooth model, i.e. after at least some pre-restorative orthodontic treatment has been done. However, the restorative feature optimizing algorithm may be implemented at any time between the start and end of ortho-restorative treatment.

The position and/or size of the restorative feature may be optimized assuming that the position of the teeth is fixed. Alternatively or additionally, the optimizing may involve moving the teeth relative to the restorative feature assuming that the position of the restorative feature is fixed.

In some cases, the optimization may include a constrained optimization. For example, constraints may be placed on the position and/or size of the restorative feature based on the goal(s). For instance, if a goal is to minimize the amount of tooth loss, the position and/or size of the restorative feature may be optimized based on minimizing the volume of tooth loss associated with the restorative feature. In some cases, a penalty function is used, which penalizes a cost function when constraint(s) is/are violated.

At 107, the optimized restorative feature is included in the ortho-restorative treatment plan. For example, a distance between the restorative feature model and the tooth model may be optimized to provide good coverage of the tooth model while minimizing tooth loss of the tooth model. Additionally or alternatively, the size of the restorative feature model relative to the tooth model may be optimized to provide good coverage of the tooth model while minimizing tooth loss of the tooth model. In some cases, the tooth model and the restorative feature model are presented to a user, for example, in an overlap view showing regions of the tooth model in which the restorative feature model overlaps with the tooth model.

At 109, the method may optionally include receiving instructions to modify aspects of ortho-restorative treatment plan. For example, a user (e.g., dental practitioner) may not be satisfied with the ortho-restorative treatment plan, and therefore want to change one or more aspects of the plan (e.g., final positions of the teeth, orthodontic movements of the teeth, and/or the size, shape, size and/or number of the restorative feature(s)). Once the user's modifications are received, at 111, an updated ortho-restorative treatment plan based on the m user's modification may optionally be generated. The steps 109 and 111 may optionally be repeated, e.g., until the user is satisfied with an ortho-restorative treatment plan.

Once a final ortho-restorative treatment plan is determined, e.g., chosen by the user, dental appliances for implementing the ortho-restorative treatment plan may be fabricated. In some examples, the dental appliances include a series of aligners (e.g., polymeric shells) that are configured to be removably worn on the patient's teeth. Each of the aligners may define cavities that are shaped and sized to accept the patient's teeth and may be shaped to resiliently apply orthodontic forces on the patient's teeth. In some cases, the dental appliances are configured to cooperate with one or more attachments bonded to the patient's teeth to apply the orthodontic forces. In some cases, one or more of the dental appliances may be a palatal expander that is configured to apply an expansion force against upper molars to expand the patient's palate. In some cases, the restorative feature(s) may be applied (e.g., bonded to teeth or implanted) to the patient's dentition after the orthodontic movements have been completed. In some cases, the restorative feature(s) may be applied to the patient's dentition during the orthodontic movements (e.g., while the appliances are worn on the patient's teeth).

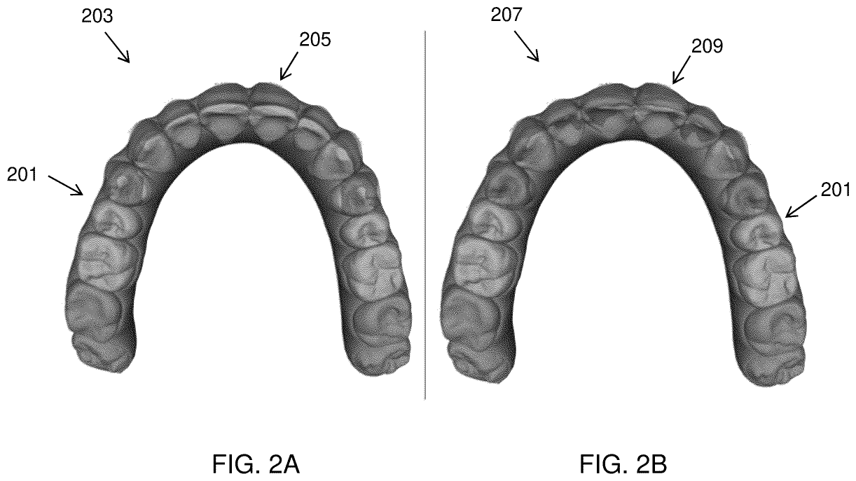

FIG. 2A shows an example of an overlap view 203 of a tooth model 201 in a target arrangement and a first restorative feature 205 for a treatment plan that has not been optimized to minimize tooth mass loss. In this case, the first restorative feature 205 is a veneer that covers labial surfaces of a number of the anterior teeth. Some natural tooth material must be removed (e.g., ground off) to apply the first restorative feature 205 onto the teeth. The ortho-restorative treatment planning algorithm did not take into account information about the mass and/or position of the teeth relative to the restorative feature 205, and the degree of filing of the original teeth before restoration.

FIG. 2B shows an example of an overlap view 207 of the tooth model 201 in the target arrangement and a second restorative feature 209 for a treatment plan that has been optimized to minimize tooth mass loss. Although some tooth material must be removed to apply the second restorative feature 209 onto the teeth, there is less tooth loss than required for applying the first restorative feature 205 in FIG. 2A. Less tooth mass loss can be desirable in order to preserve natural anatomical tooth features and maintain the structural integrity of the teeth.

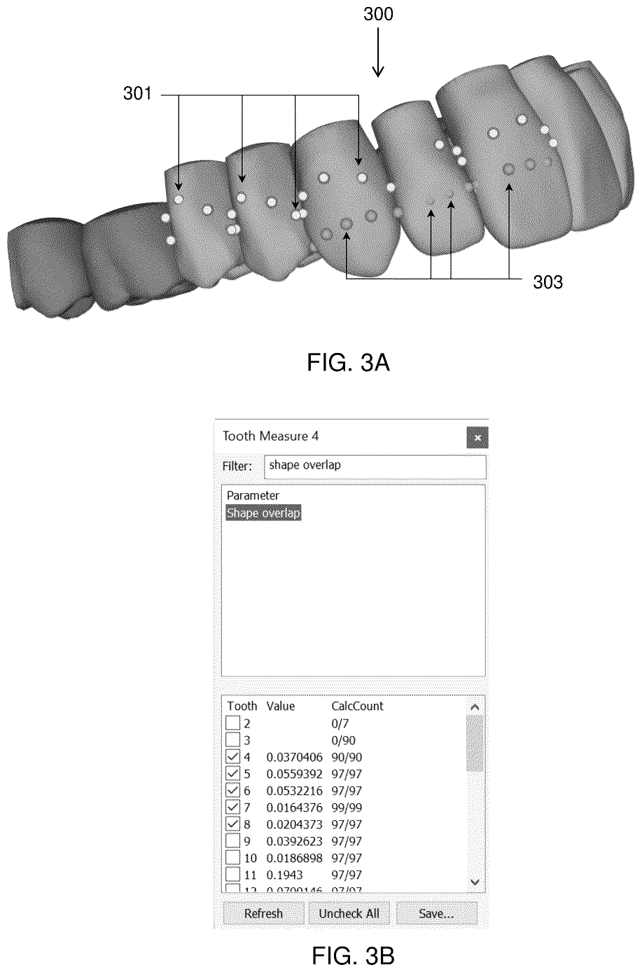

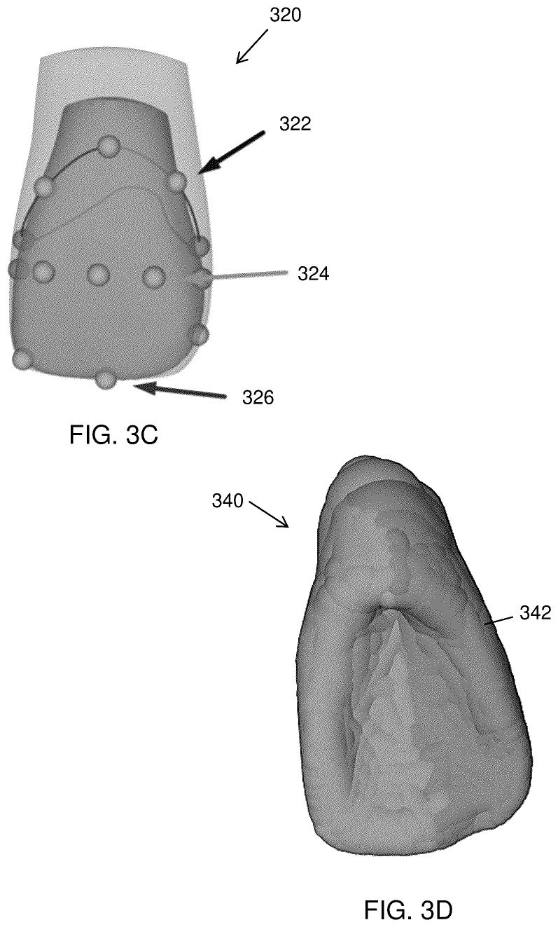

Minimizing tooth mass loss may include considering how the shape of the restorative feature overlaps with the shape of the teeth. As discussed, the shape of digital object may refer to its geometric form or external boundary. Thus, the shape of a restorative feature model and the tooth model can refer to their respective external boundaries. The distance between overlapping regions of the two shapes may be used to minimize the amount of tooth loss. The following discussion with reference to FIGS. 3A-5C describes details of example methods for determining distances between overlapping regions and minimizing tooth volume loss.

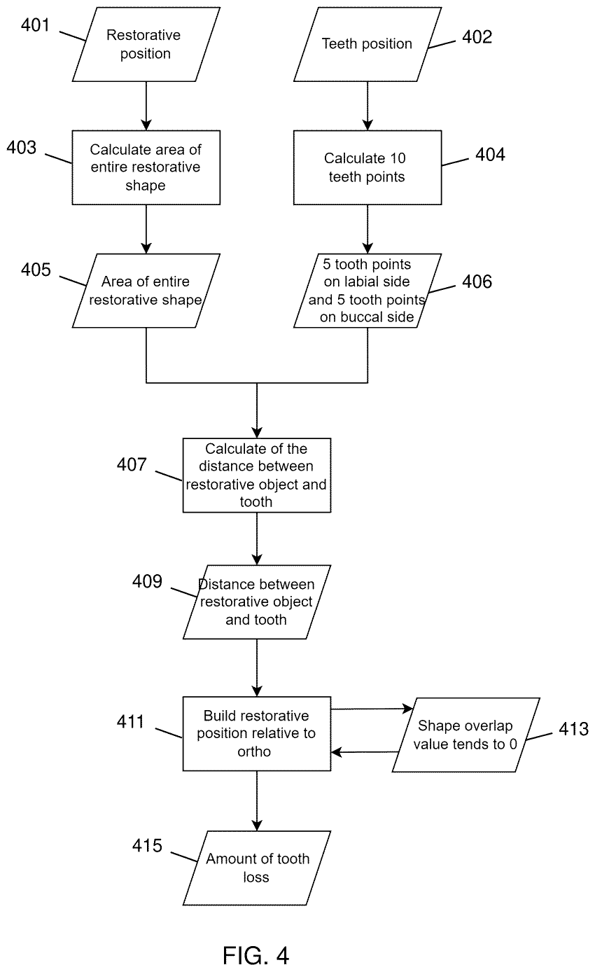

FIGS. 3A-4 show aspects of example methods for minimizing tooth loss that include simplifying the tooth model using a number of representative tooth points (e.g., rather than a full mesh shape). This simplifies the shape of the tooth model to increase the speed of calculation of the overlap between the tooth model and the restorative feature model.

FIG. 3A shows an example tooth model 300 marked with tooth points 301 that represent an approximate shape of the part of the tooth model 300 where a restorative feature model contacts or intersects with the tooth model 300. The tooth points 301 are used instead of the entire mesh of the tooth model 300 because calculating the intersection between the mesh of the tooth model 300 and the restorative feature model may be resource intensive and/or slow. Thus, the number of tooth points 301 is less than the number of points defining the entire mesh the tooth model 300. The number of tooth points 301 may be limited to a predetermined number. In one example, each tooth may be represented by a maximum of ten tooth points 301, with five points on the labial side and five points on the buccal side of each tooth.

A shape overlap calculation may be used to determine distances between the tooth points 301 and the restorative feature shape. The shape overlap may be calculated as the squared distance between the tooth points 301 and restorative feature shape (e.g., in millimeters squared (mm²)). The shape overlap may then be used to calculate the distance between the restorative feature model and the tooth points 301, and then used to determine the amount of tooth loss associated with the restorative feature. The following are example calculations:
1. Calculation of the distance between the restorative object of anterior segment and the tooth of anterior segment:
1.1 For tooth representation we use only 10 points: 5 points on labial side and 5 points on buccal side;
1.2 The entire shape is used for the restorative object;
1.3. For points inside shape we assume, that the distance is 0;
1.4. The shape overlap value tends to 0, due to which the exact determination of the amount of tooth loss that needs to be filed away during the restoration occurs.
2. Calculation of the distance between the restorative object of posterior segment and tooth of posterior segment:
2.1. For tooth representation we use only 10 points: 5 points on labial side and 5 points on lingual side;
2.2. The entire shape is used for the restorative object;
2.3. For points inside shape we assume, that the distance is 0;
2.4. The shape overlap value tends to 0, due to which the exact determination of the amount of tooth loss that needs to be filed away during the restoration occurs.

In FIG. 3A, those points in which the restorative feature shape reside within the tooth points 301 of tooth model 300 are represented as inside restorative points 303. These inside restorative points 303 indicate areas in which there is unnecessary tooth mass loss and are penalized. FIG. 3B shows example shape overlap values calculated for several teeth.

FIG. 3C shows another example tooth model 320 that is represented by tooth points. In this example, the tooth model 320 is represented by a first set of points 322 along the gingival line, a second set of points 324 along a middle portion of the tooth defined by a mass center of the tooth crown, and a third set of points 326 along an incisal edge of the tooth model. The position of the tooth model 320 may be fixed based on, for example, a final position of the tooth model according to the restorative treatment plan. A goal is to place the restorative feature in such a way the restorative feature covers the tooth 320 while minimizing tooth loss.

FIG. 3D shows an example of a tooth model 340 showing an overlap region 342 where a restorative feature overlaps with the tooth model 340. Note that in this case, the tooth model 340 is represented as capsules (see, e.g., FIG. 5D). If, for example, the overlap region 342 is approximated by about 100 capsules of the tooth model 340, to determine whether the tooth 340 is covered by restorative feature, it may be enough to check if all of a set of points (e.g. all of the second set of points 324 in FIG. 3C (e.g., about 10 points)) are inside any of the about 100 capsules of the overlap region 342. That equates to only about 1000 operations. In a similar way, any of a set of points (e.g., second set of points 324) that are outside of the tooth 340 may be calculated quickly. Without using these sets of points to approximate the tooth model 340, the optimization calculation may take about 100-1000 times more time to arrive at the ortho-restorative treatment result.

FIG. 4 shows a flowchart indicating an example process for minimizing tooth loss reduction. At 403, the area of the restorative shape is determined based on the restorative position 401 (relative to the teeth position) as input. At 404, a predetermined number of points (e.g., 10) on the tooth shape is calculated based on the teeth position 402 (relative to the restorative position) as input. At 407, the distance between the restorative feature and the teeth/tooth is calculated using the area of the restorative shape 405 and the position of the tooth points (e.g., 5 points on labial side and 5 tooth points on buccal side) 406 as input. At 411, the distance between the restorative feature and the teeth/tooth 409 is used as input to build/calculate the position of the restorative feature relative to the teeth/tooth. This distance can be iteratively adjusted and recalculated 411 until the shape overlap value tends to zero 413. At 415, the amount of tooth loss is determined based on a resultant optimized shape overlap calculation.

FIGS. 5A-5C show aspects of example methods for minimizing tooth loss that include simplifying the restorative feature model using a number of representative tooth points (e.g., rather than a full mesh shape of the restorative feature). This simplifies the shape of the restorative feature model to increase the speed of calculation of the overlap between the tooth model and the restorative feature model.

FIGS. 5A and 5B show an example tooth model 501 and a restorative feature model 505. The restorative feature model 505 includes restorative points 507a and 507b that represent an appropriate shape of the restorative feature model 505. Approximating the shape of the restorative feature model 505 with points 507a and 507b may be useful in cases where a final (e.g., ideal) position of the restorative feature model 505 is known. Tooth loss minimizing may include aligning the tooth model 501 such that surfaces of the tooth model 501 are covered by the restorative feature model 505. Tooth mass loss may correspond to the volume of the tooth model 501 that sticks out of the restorative feature model 505 (i.e., not covered by the restorative feature model 505). Restorative points 507b that are inside (or covered by) the tooth model 501 can be penalized. More formally, for a pre-defined set of restorative points of the restorative feature model 505, a metric will be zero if all restorative points are outside of tooth model 501. The deeper that a restorative point of restorative feature model 505 is inside tooth model 501, the bigger the metric value will be. These metric values are based on distances, e.g., 511, between the points 507b on the shape/surface of the restorative feature 505 and points on the shape/surface of the tooth model 501. Points 507a on the shape/surface of the restorative feature model 505 that are outside of the shape/surface of the tooth model 501 are not penalized.

The location of the restorative points 507a and 507b representing the shape of the restorative feature model 505 may be determined in any of various ways. For example in this case, as illustrated in FIG. 5B, a mesh decimation is performed, to reduce the number of polygon (triangle) faces in the mesh. Then, a center point of each polygon 509 (in this case triangle) is identified. The center point of each polygon 509 can be defined as a centroid of a face of the polygon (e.g., triangle). The center points of each polygon can correspond to the restorative points 507a and 507b of the restorative feature model 505. In addition, the face area of each polygon may be used as weight for the corresponding characteristic point (e.g., with larger areas having higher weights). Then, the restorative points 507a and 507b of the restorative feature model 505 are checked to see if they are outside of the tooth model 501 (e.g., which may be represented by capsules). The distances 511 between the restorative points 507b and the tooth model 501 can then be calculated.

Different points 507a and 507b of the restorative feature model 505 may be treated in different ways. For example, in some cases where a restorative feature model 505 corresponds to a veneer, only the points that cover a buccal side and/or near the incisal edge of the tooth model 501 may be considered. Additionally or alternatively, we can set how far the restorative features model 505 points 507a/507b shall be from tooth model 501 to specify different veneer types.

FIG. 5C shows a flowchart indicating an example process for optimizing a distance between the restorative feature model 505 and the tooth model 501 of FIGS. 5A and 5B. At 521, a set of weighted restorative points 507a, 507b of the restorative feature model 505 are determined. In some cases, this may include decimating a shape of the restorative feature model 505. Decimating the shape may include simplifying the geometry, for example, by reducing the number of polygon (e.g., triangles) faces in the restorative feature model, 505 while maintaining its overall form. Setting restorative points 507a, 507b may include using polygon face centroids as the restorative points 507a, 507b. The face area of each polygon may be used as the weight for the corresponding restorative point.

At 523, signed distances between the restorative points 507a, 507a of the restorative feature model 505 and the tooth model 501 are determined. In general, a signed distance refers to the calculated distance between a restorative point 507a, 507b and the tooth model 501, where the sign of the distance indicates whether the restorative point 507a, 507a lies inside or outside the tooth model 501. This is used to identify the restorative points 507b that are inside the tooth model 501 and that are associated with tooth mass loss. Determining the signed distances can include using capsules to approximate a distance between a restorative point 507a, 507b and the tooth model 501. Equations 1 and 2 below can be used to approximate a distance using capsules, such as the capsule shown in FIG. 5D.

$$Distance ( C , Capsule ( AB , r ) ) = Distance ( C , A B ) - r \qquad Equation 1$$

Equation 1 indicates the distance from a capsule to a point, where C is point, AB is a segment that defines an axis of capsule, and r is the radius of capsule.

$$Distance ( C , \{ capsule Capsule ∈ Approximation \} ) = {min}_{capsule} Distance ( C , capsule ) \qquad Equation 2$$

Equation 2 indicates the distance from the approximation to a point.

Returning to the flowchart of FIG. 5C, at 525, a penalty is calculated for each restorative point. In some examples, a penalty function for each restorative point is defined as equal to zero if the characteristic point is outside the tooth model, and positive if the restorative point is inside the tooth model. This calculation is illustrated in Equation 3 below.

$$\begin{matrix}Penalty ( {f}_{R} , Tooth ) = Penalty ( centroid ( {f}_{R} ) , Tooth ) \\ = Penalty ( centroid ( {f}_{R} ) , Approximation ) \\ = - min ( 0 , D ( {f}_{R} , T ) )\end{matrix} \qquad Equation 3$$

The thickness of restorative feature can be emulated by penalizing distances below the thickness of the restorative feature model using Equation 4 below.

$$Penalty ( {f}_{R} , Tooth ) = {Thickness}_{R} - min ( {Thickness}_{R} , D ( {f}_{R} , T ) ) \qquad Equation 4$$

The surface of the restorative feature model can be divided into zones (e.g., buccal, incisal, labial) and the thickness of the restorative feature model may vary depending on the zone.

Returning to the flowchart of FIG. 5C, at 527, a weighted sum of the penalized restorative points is calculated. This can involve iterating through all restorative points and summing penalties weighted by polygon face area for each restorative point. An example of this calculation is illustrated in Equation 5 below.

$$Overlap ( Restorative , Tooth ) = {\sum }_{{f}_{R}} Penalty ( {f}_{R} , Tooth ) * Area ( {f}_{R} ) / {\sum }_{{f}_{R}} Area ( {f}_{R} ) \qquad Equation 5$$

In some examples, the optimizing algorithm may be configured to change a size of the restorative feature model by scaling. For example, the size one or more of the polygons (e.g., triangles) that form the restorative feature model may be changed by scaling. In some cases, this does not include changing the topology of the restorative feature model. That is, in some examples, the topology of the restorative feature model may be determined prior to optimizing its size and/or position relative to the tooth/teeth model. For instance, after changing a scale of an i-th triangle, a point in the middle of the i-th triangle may remain in the middle. This can allow any changes in the size of restorative feature to be recomputed quickly.

In some cases, the ortho-restorative treatment planning software may be configured to determine the best type of restorative feature to use. Aspects of such an example are shown in FIGS. 5E-5H, which show example tooth models 550 and 560. FIGS. 5E and 5F show a tooth model 550 with areas of overlap 552 of the tooth model 550 with a restorative feature 554 shown as shaded areas. FIGS. 5G and 5H show a tooth model 560 with areas of overlap 562 of the tooth model 560 with a restorative feature 564 shown as shaded areas.

To estimate the best type of restorative feature (e.g., crown, veneer, filling, inlay, onlay, edge bonding, composite, implant, bridge and/or prosthetics) to use, an ortho-restorative treatment plan without implementing the shape overlap rules may be built. The most probable type of restorative feature may be estimated based on the type of tooth and how the restorative feature model overlaps the tooth model. For example, the tooth model 550 in FIGS. 5E and 5F is an upper central tooth with a restorative feature model 554 overlap that is consistent with a composite type of restorative feature. As another example, the tooth model 560 in FIGS. 5G and 5H is an incisor tooth with a restorative feature model 564 overlap that is consistent with a veneer type of restorative feature. In some cases, user (e.g., doctor) preferences may also be considered in estimating the type of restorative feature. After the best type of restorative feature is estimated, the ortho-restorative treatment plan can be rebuilt using optimizing techniques described herein using a set of rules related to the estimated best restorative type.

In some examples, the restorative feature is treated as an abstract object—that is, without regard to the type or material of restorative feature. In other cases, the type and/or material of the restorative feature may be considered. For example, the ortho-restorative treatment planning software may be configured to allow placement of restorative features of different types and/or materials. Different optimization (overlap) rules may be defined for the specific restorative feature type and/or material used. In some cases, specific sub-types of restorative features may be specified. For example, different sub-types of veneers or crowns may be specified.

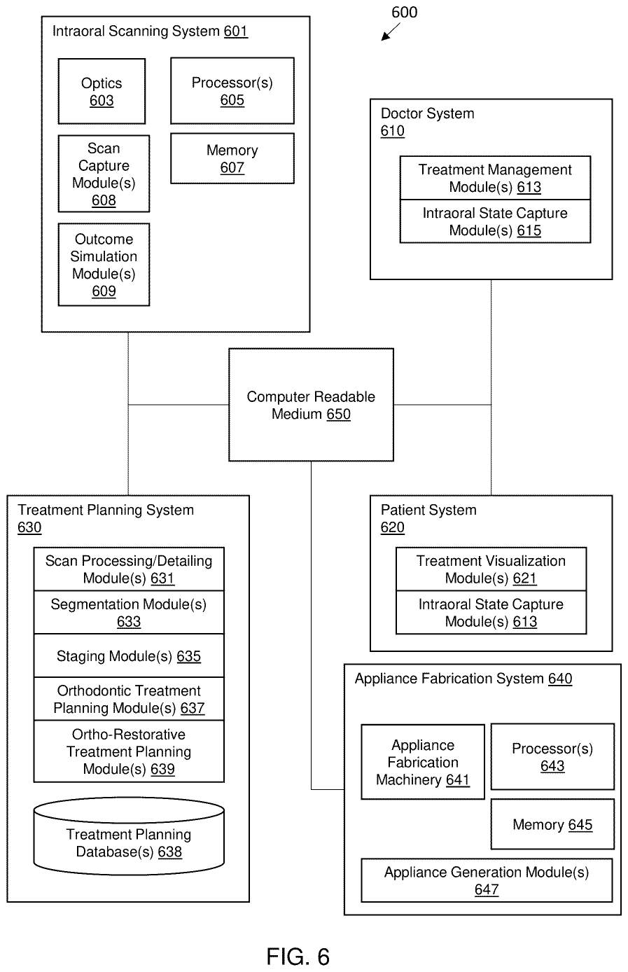

FIG. 6 is a diagram illustrating one variation of a computing environment 600 that may generate one or more ortho-restorative (and, in some cases, orthodontic only) treatment plans specific to a patient. The computing environment may also fabricate dental appliances that may accomplish the treatment plan to treat a patient, under the direction of a dental professional, using the activated attachments described herein. The example computing environment 600 shown in FIG. 6 may include an intraoral scanning system 601, a doctor system 610, a treatment planning system 630 (e.g., technician system), a patient system 620, an appliance fabrication system 640, and computer-readable medium 650. In some variations a computing environment (dental computing system) 600 may include just one or a subset of these systems (which may also be referred to as sub-systems of the overall system 600). Further, one or more of these systems may be combined or integrated with one or more of the other systems (sub-systems), such as, e.g., the patient system and the doctor system may be part of a remote server accessible by doctor and/or patient interfaces. The computer readable medium 650 may be divided between all or some of the systems (subsystems). For example, the treatment planning system 630 and appliance fabrication system 640 may be part of the same sub-system and may be on a computer readable medium 650. Further, each of these systems may be further divided into sub-systems or components that may be physically distributed (e.g., between local and remote processors, etc.) or may be integrated.

The intraoral scanning system 601 may include an intraoral scanner as well as one or more processors for processing images. For example, an intraoral scanning system 601 can include optics 603 (e.g., lens(es), filters, light sources, etc.), processor(s) 605, a memory 607, scan capture modules 608, and outcome simulation modules 609. In general, the intraoral scanning system 601 can capture one or more images of a patient's dentition. Use of the intraoral scanning system 601 may be in a clinical setting (doctor's office or the like) or in a patient-selected setting (the patient's home, for example). In some cases, operations of the intraoral scanning system 601 may be performed by an intraoral scanner, dental camera, cell phone or any other feasible device.

Any of the component systems or sub-systems of the dental computing environment 600 may access or use the methods and apparatuses described herein. For example, the doctor system 610 may include treatment management modules 613 and intraoral state capture modules 615 that may access or use both the 3D model of the patient's dentition and one or more digital models of the prefabricated attachments. The doctor system 610 may provide a “doctor facing” user interface to the computing environment 600. The treatment management modules 613 can perform any operations that enable a doctor or other clinician to manage the treatment of any patient. In some examples, the treatment management modules 613 may provide a visualization and/or simulation of the patient's dentition with respect to a treatment plan. In some examples, the treatment management modules 613 can enable the doctor to modify or revise a treatment plan, particularly when images provided by the intraoral state capture modules 615 indicate that the movement of the patient's teeth may not be according to the treatment plan. The doctor system 610 may include one or more processors configured to execute any feasible non-transitory computer-readable instructions to perform any feasible operations described herein.

The doctor system 610 may allow the doctor to request whether any existing attachments on a patient's teeth may be activated in a secondary treatment plan. For example, the treatment management module 613 may include a user interface for the doctor that allows the doctor to interactively communicate with a secondary treatment module 634 of the treatment planning system 630. The doctor may submit a current scan of the patient's teeth with existing attachments on the patient's teeth. The scan may be captured using one or more intraoral state capture modules 615. The doctor may also submit one or more prior scans of the patient's teeth, for example, with or without the attachments on the teeth. The doctor may also submit a 3D model of the patient's dentition in a final desired tooth configuration resulting from the secondary treatment. Such 3D model may be formed using the treatment management module 613.

The secondary treatment module 634 is configured to determine whether any of the existing attachments could be actively used in the secondary treatment and transmit associated information back to the doctor system 610. For example, the secondary treatment module 634 may transmit to the doctor system 610 whether any of the existing attachments should be removed, any of the existing attachments may be used as active attachments in the secondary treatment plan, and/or any of the existing attachments may be used as passive attachments in the secondary treatment plan. The secondary treatment module 634 can also be configured to calculate one or more secondary treatment plans with any confirmed active attachments and/or passive attachments integrated therein.

The treatment planning system 630 may include any of the methods and apparatuses described herein. Although not shown, the treatment planning system 630 can include one or more processors configured to execute any feasible non-transitory computer-readable instructions to perform any of the operations described herein. The treatment planning system 630 may include one or more scan processing/detailing modules 631, one or more segmentation modules 633, one or more staging modules 635, one or more orthodontic treatment modules 637, one or more ortho-restorative treatment planning modules 639, and one or more treatment planning databases 638. In general, the treatment planning system 630 can determine a treatment plan for any feasible patient. The scan processing/detailing modules 631 can receive or obtain dental scans (such as scans from the intraoral scanning system 601) and can process the scans to remove scan errors and, in some cases, enhancing details of the scanned image.

A treatment planning system 630 may include a segmentation module 633 that can segment a dental model into separate parts including separate teeth, gums, jaw bones, attachments, and the like. The staging modules 635 may determine different stages of a treatment plan. Each stage may correspond to a different dental appliance and may use the same or different attachments. The staging modules 635 may also determine the final position of the patient's teeth, in accordance with a treatment plan. Thus, the staging modules 635 can determine some or all of a patient's treatment plan. In some examples, the staging modules can simulate movement of a patient's teeth in accordance with the different stages of the patient's treatment plan using the determined attachments.

The treatment planning system 630 may include one or more orthodontic (e.g., orthodontic only) treatment planning modules 637 and one or more ortho-restorative treatment planning modules 639. The orthodontic treatment planning module 637 can perform operations related to generating orthodontic treatment plans, and the ortho-restorative treatment planning module 639 can perform operations related to generating an ortho-restorative treatment plan (i.e., including the use of one or more restorative features/devices). In some cases, the orthodontic treatment planning module 637 and the ortho-restorative treatment planning module 639 are separate modules, while in other cases they are at least partially integrated, sometimes as a single treatment planning module.

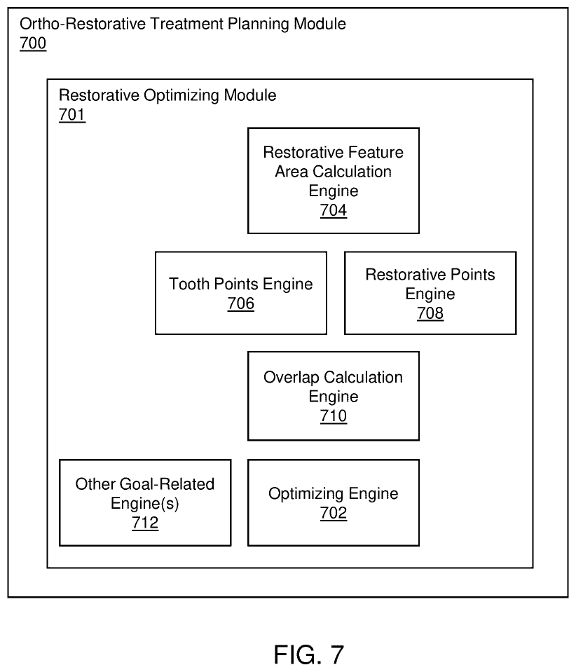

The orthodontic treatment planning module 637 and the ortho-restorative treatment planning module 639 may be configured to coordinate with one or more of the scan processing/detailing module(s) 631, segmentation model(s) 633 and/or staging module(s) 635 to generate the treatment plans, and to store the treatment plans in the treatment planning database 638. Details regarding an example ortho-restorative treatment planning module 639 with respect to the restorative feature optimizing techniques described herein are described herein with reference to FIG. 7.

The patient system 620 can include treatment visualization modules 621 and intraoral state capture modules 615. In general, the patient system can provide a “patient facing” interface to the computing environment 600. The treatment visualization modules 621 can enable the patient to visualize how a treatment plan has progressed and also visualize a predicted outcome (e.g., a final position of teeth). In some examples, the patient system 620 can capture dentition scans for the treatment visualization modules 621 through the intraoral state capture modules 623. The intraoral state capture modules can enable a patient to capture his or her own dentition through the intraoral scanning system 601. Although not shown here, the patient system 620 can include one or more processors configured to execute any feasible non-transitory computer-readable instructions to perform any feasible operations described herein.

The appliance fabrication system 640 can include appliance fabrication machinery 641, processor(s) 643, memory 645, and appliance generation modules 647. In general, the appliance fabrication system 620 can directly or indirectly fabricate dental appliances to implement a treatment plan. In some examples, the treatment plan may be stored in the treatment planning database(s) 638.

The appliance fabrication machinery 641 may include any feasible implement or apparatus that can fabricate any suitable dental appliance. The appliance generation modules 647 may include any non-transitory computer-readable instructions that, when executed by the processor(s), can direct the appliance fabrication machinery 641 to produce one or more dental appliances. The memory 645 may store data or instructions for use by the processor(s) 643. In some examples, the memory 645 may temporarily store a treatment plan, dental models, or intraoral scans.

The computer-readable medium 650 may include some or all of the elements described herein, with respect to the computing environment 600. The computer-readable medium 650 may include non-transitory computer-readable instructions that, when executed by a processor, can provide the functionality of any device, machine, or module described herein.

FIG. 7 illustrates an example of an ortho-restorative treatment planning module 700. The ortho-restorative treatment planning module 700 includes a restorative optimizing module 701 that may be configured to optimize one or more clinical and/or aesthetic goals related to one or more restorative features used in an ortho-restorative treatment plan. The ortho-restorative treatment planning module 700 may include other modules and engines for generating the ortho-restorative treatment plan, which are not shown in FIG. 7 for simplicity.

In this example, the restorative optimizing module 701 includes an optimizing engine 702 that is configured to optimize one or more clinical and/or aesthetic goals related to one or more restorative features used in the ortho-restorative treatment. The optimizing engine 702 may be configured to implement any type of rule (clinical and/or aesthetical) either as a target or as a constraint. Example rules may be based on a goal function (e.g., that is minimized or maximized) and/or equals a weighted sum of targets. In this example, the optimizing engine 702 is configured to at least minimize tooth mass loss related to one or more restorative features used in the ortho-restorative treatment.

A restorative feature area calculation engine 704 can be configured to calculate an area of a shape of a restorative feature model (e.g., entire area of the shape) using a position of the restorative feature model in virtual space (e.g., relative to the tooth) as input. In some examples, a restorative points engine 708 can be configured to simplify optimization by representing a shape of the restorative feature model with a set of restorative points. For instance, the set of restorative points may correspond to center points of polygons (e.g., of a simplified mesh) of the restorative feature model. See, e.g., FIGS. 5A-5C. In some examples, a tooth points engine 706 can be configured to simplify optimization by representing a shape of the tooth model with a set of tooth points. For instance, the set of tooth points may include a predetermined number of points (e.g., 5, 10, 15, 20, or more) at one or more regions (e.g., along the gingiva, along the incisal edge, along the center, on the buccal side, on the occlusal side and/or on the lingual side of a tooth) of the tooth model. See, e.g., FIGS. 3A-3D.

An overlap calculation engine 710 can be configured to calculate the overlap between the tooth model and the restorative feature model. This calculation may include using results from the restorative feature area calculation engine 704, tooth points engine 706 and/or the restorative points engine 708 to calculate distances between the restorative feature model and the tooth model at different regions. This distance output from the distance calculation engine 710 can be used by the tooth optimizing engine 702 to determine an optimized position and/or size of the restorative feature model relative to the tooth model to minimize the amount of tooth mass loss associated with the restorative feature. For example, the position and/or size of a restorative feature model relative to the tooth model can be iteratively adjusted and calculated until a shape overlap value tends to zero, thereby minimizing the tooth mass loss. The tooth optimizing engine 702 can provide the optimized position and/or size of the restorative feature model and/or an amount of tooth mass loss associated with the optimized position and/or size as output. This information can be used to generate one or more an ortho-restorative treatment plans by the ortho-restorative treatment plan module 700. In some cases, the overlap and distance information may be presented to the user, for example, as one or more images and/or one or more 3D models on a user interface.

The restorative optimizing module 701 may optionally include one or more other goal-related engines 712 that is/are configured to calculate other metrics related to optimizing one or more other goals, such as minimizing a duration of the ortho-restorative treatment plan, minimizing breaching of dentin, minimizing the number of dental attachments, and/or other goals. These metrics may be used by the tooth optimizing engine 702 to optimize one or more treatment aspects related to the restorative feature.

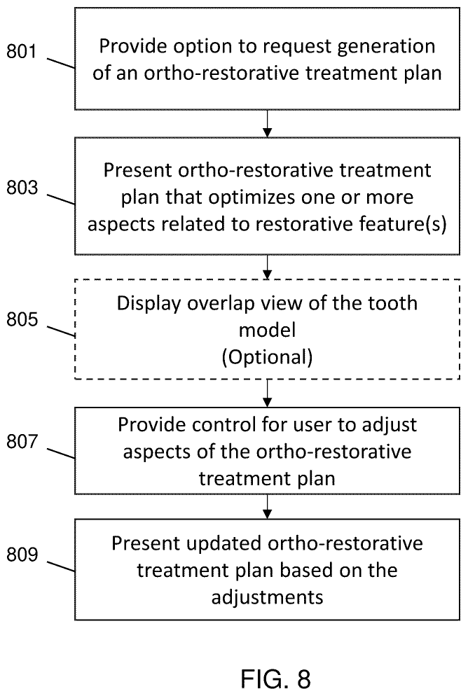

FIG. 8 shows a flowchart indicating an example user interface process for interactively presenting one or more ortho-restorative treatment plans. At 801, the user interface provides an option for a user to request the generation of an ortho-restorative treatment plan. The user may choose to use an ortho-restorative treatment plan compared to, for example, an orthodontic only treatment plan (where no restorative feature is used). In some cases, the user interface may be configured to generate and simultaneous present one or more ortho-restorative treatment plans in addition to one or more orthodontic only treatment plans, so that the user can compare the plans (e.g., viewable side-by-side). In some examples, the user inputs a type (e.g., desired type) of restorative feature (e.g., veneer, crown, implant, and the like) via the user interface.

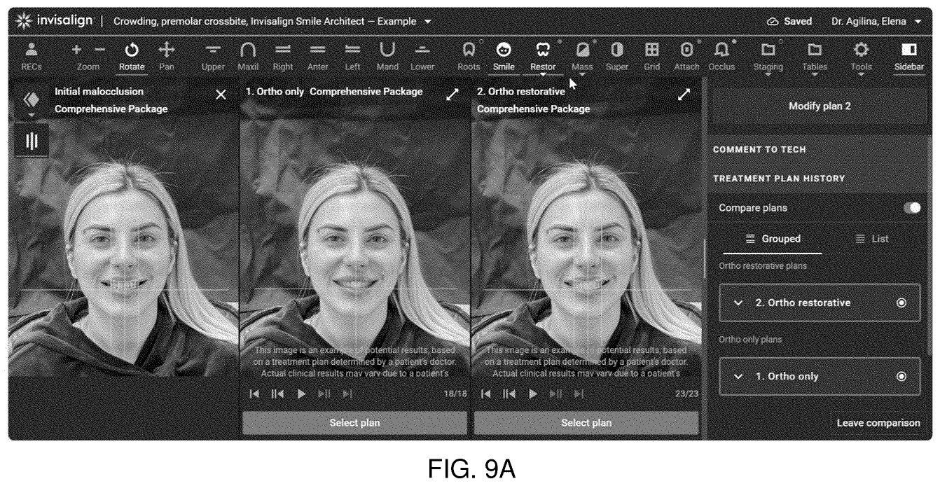

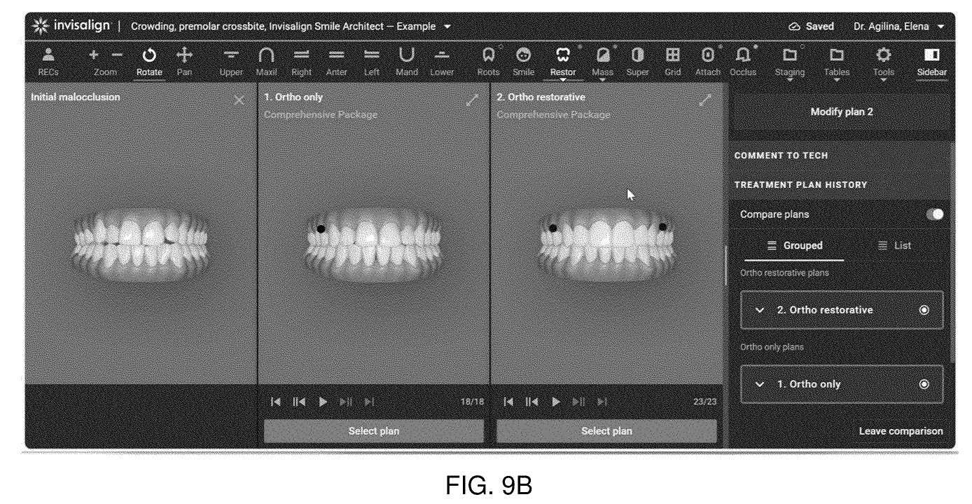

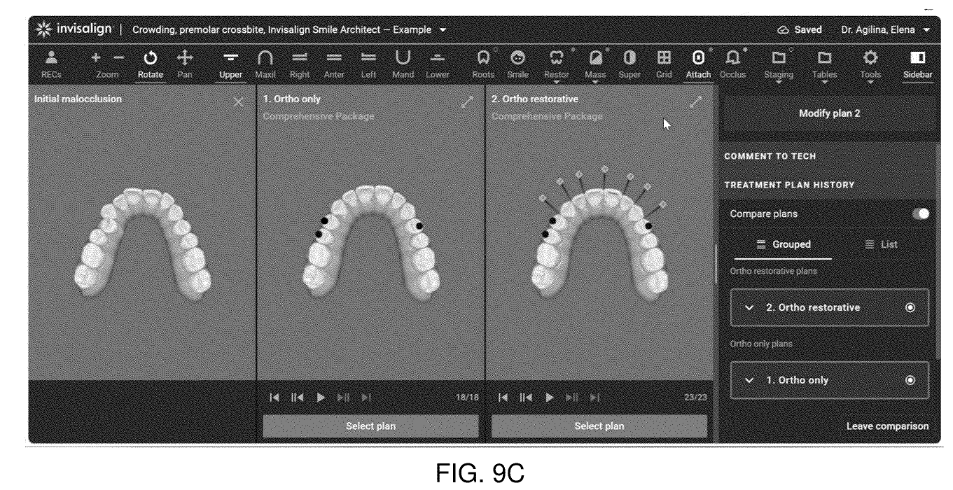

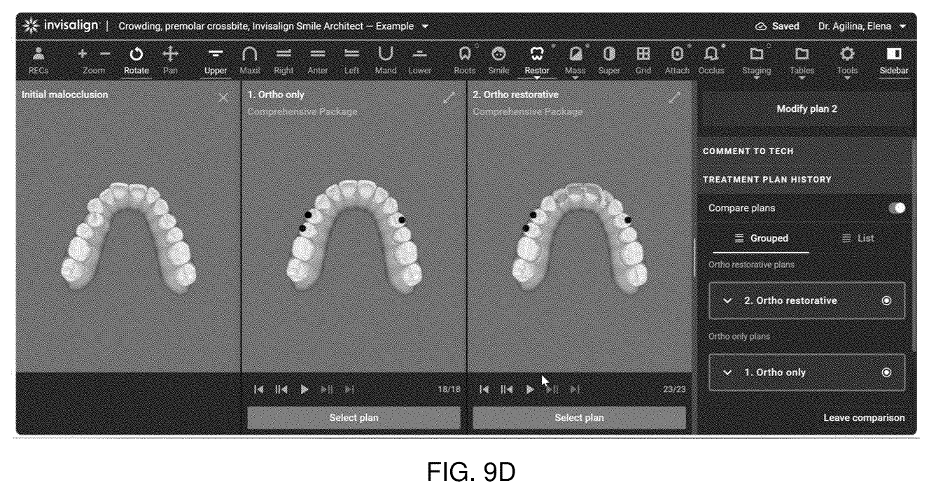

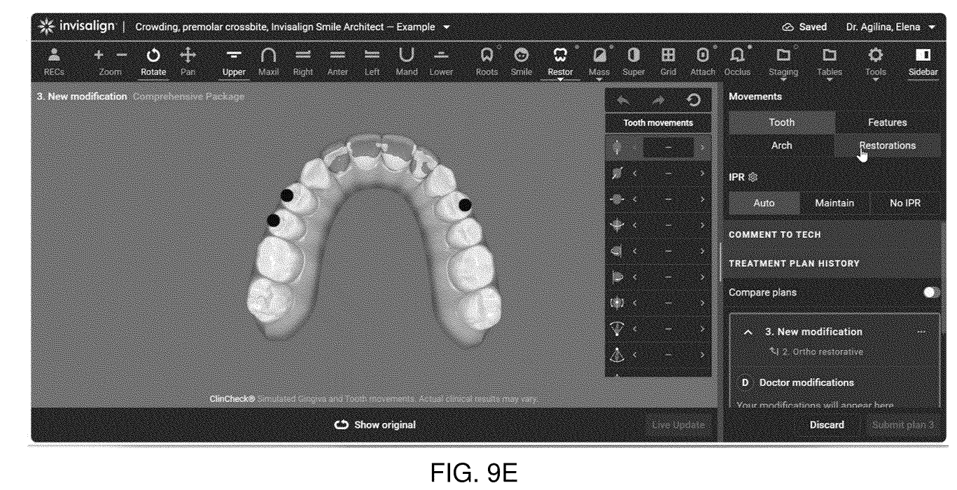

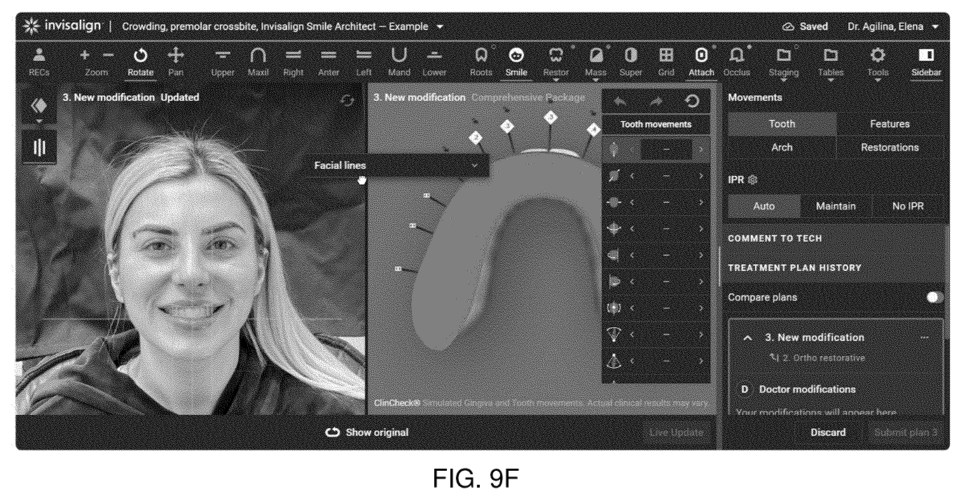

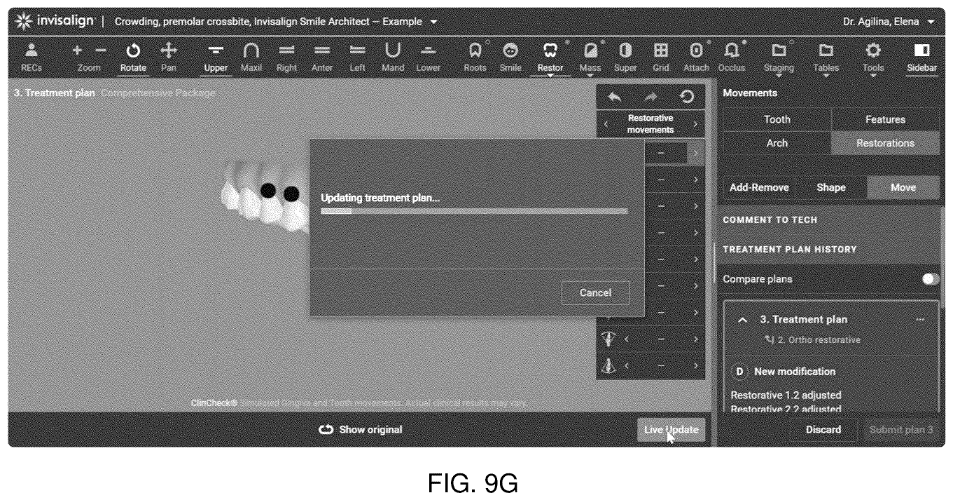

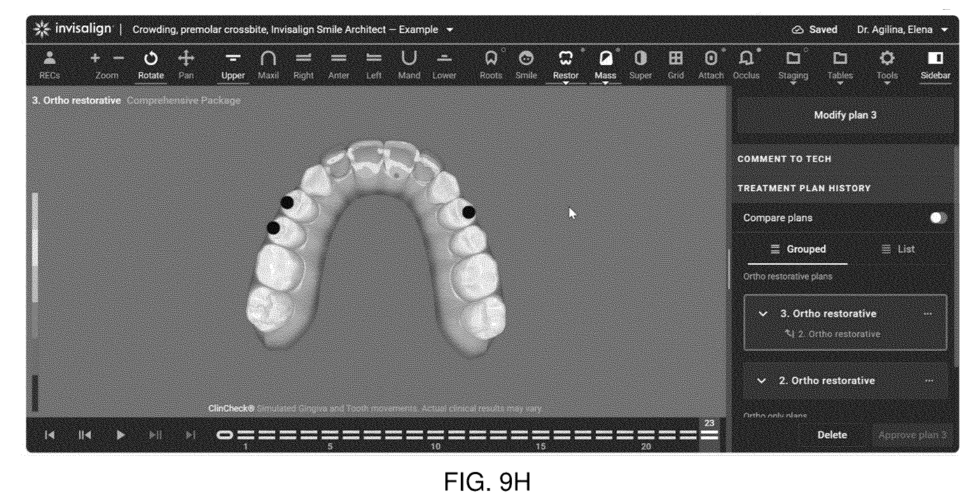

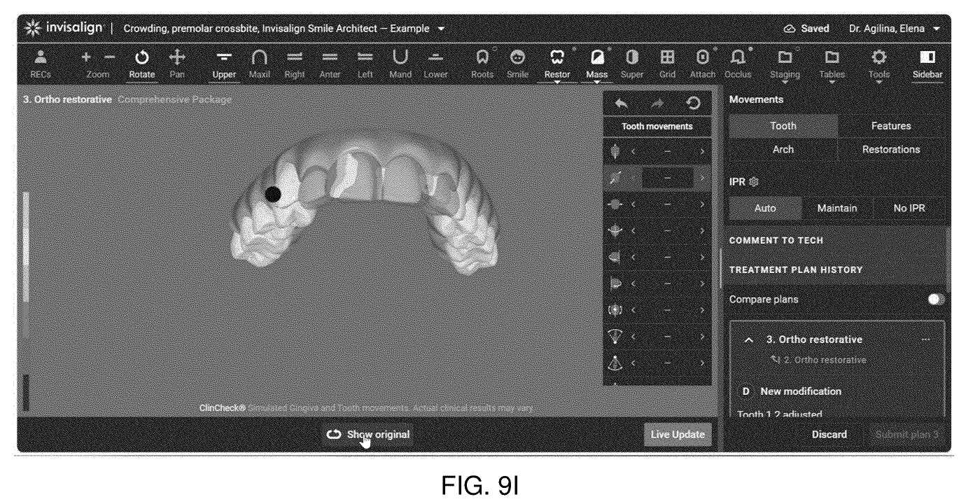

FIG. 9A shows an example user interface with options for orthodontic only treatment and ortho-restorative treatment for a patient. In some cases, the system may be configured to recommend or automatically choose an ortho-restorative treatment plan (e.g., rather than an orthodontic only treatment plan) based on the patient's initial dentition and treatment goals.

Once an ortho-restorative treatment plan is generated, at 803 aspects of the ortho-restorative treatment plan is presented on the user interface. Tooth models of the ortho-restorative treatment plan and/or ortho-only plan may be presented, such as initial, intermediate and target (final) arrangements of the teeth may be displayed. The tooth models may be represented as 2D images and/or digital 3D models. The user interface may allow a user to manipulate the view of the 2D image and/or 3D models. For example, the user interface may provide controls for the user to rotate the images/models and move individual objects, such as teeth and/or the restorative feature(s). FIG. 9B shows another example user interface illustrating front view images of target tooth arrangements of a patient's teeth according to ortho-only and ortho-restorative treatment plans. FIG. 9C shows occlusal view images of the final tooth arrangements of the patient's teeth.

As discussed, the ortho-restorative treatment plan can be optimized based on one or more aspects (e.g. clinical and/or aesthetic goals) related to the restorative feature, as described herein. For example, the ortho-restorative treatment plan may be optimized based on minimizing tooth mass loss, minimizing tooth mass loss for a specific tooth only, minimizing treatment time and/or other optimizing aspects. In some cases, the system determines which clinical and/or aesthetic goal(s) to optimize. In some cases, the user interface may provide an option for the user to choose one or more clinical and/or aesthetic goals to optimize.

At 805, the user interface may optionally display an overlap view of the tooth model. The overlap view may show regions in the tooth model which overlap with the restorative feature model in an optimized position. In some cases, just the tooth model is shown with the areas of tooth mass loss associated with the restorative feature. In some cases, the restorative feature model is shown overlapping with the tooth model. FIGS. 9D and 9E show example overlap views for the tooth model (occlusal perspective) for an ortho-restorative treatment plan. Other examples of overlap views include FIGS. 2A, 2B, 3C, 3D, 5A and 5E-5H.

At 807, the user interface may provide a control for the user to adjust aspects of the ortho-restorative treatment plan. For example, the user interface may allow the user to change movements and/or positions of one or more teeth (e.g., in a final arrangement). The user interface may allow the user to change aspects of the restorative feature, such as the type of restorative feature and/or a position of the restorative feature model (e.g., relative to the tooth model). FIG. 9F shows an example user interface that includes controls for modifying tooth movements of a patient's teeth. Once the user saves any modifications, the ortho-restorative treatment planning software may generate an updated ortho-restorative treatment plan based on the modifications.

At 809, the user interface presents the updated ortho-restorative treatment plan based on any user modifications. FIG. 9G shows an example user interface showing the ortho-restorative treatment plan being updated.

Any of the user interfaces described herein may be configured to display a heatmap view that shows locations and/or amounts of tooth mass modification of the tooth model (e.g., at targe (final) stage and/or any intermediate stage of the treatment plan) associated with the restorative feature. The heatmap view may indicate a scale representing the change in distance between a tooth model in an initial arrangement (e.g., prior to treatment) and a tooth model in a target (final) arrangement at multiple locations. For example, positive distance values (“addition grades”) can represent locations where tooth mass addition will occur, negative distance values (“reduction grades”) can represent locations where tooth mass reduction will occur, and zero can represent locations where no changes in tooth mass will occur. In some cases, the heatmap view may represent the different grades in different colors. FIGS. 9H and 9I show example view of heatmap views of an example tooth model.

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits described herein.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

Any of the methods (including user interfaces) described herein may be implemented as software, hardware or firmware, and may be described as a non-transitory computer-readable storage medium storing a set of instructions capable of being executed by a processor (e.g., computer, tablet, smartphone, etc.), that when executed by the processor causes the processor to control perform any of the steps, including but not limited to: displaying, communicating with the user, analyzing, modifying parameters (including timing, frequency, intensity, etc.), determining, alerting, or the like. For example, any of the methods described herein may be performed, at least in part, by an apparatus including one or more processors having a memory storing a non-transitory computer-readable storage medium storing a set of instructions for the processes(s) of the method.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

As described herein, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The processor as described herein can be configured to perform one or more steps of any method disclosed herein. Alternatively or in combination, the processor can be configured to combine one or more steps of one or more methods as disclosed herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

In general, any of the apparatuses and methods described herein should be understood to be inclusive, but all or a sub-set of the components and/or steps may alternatively be exclusive, and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method of ortho-restorative treatment planning, the computer-implemented method comprising:
accessing an initial tooth model representing an initial tooth arrangement of a patient's teeth;
generating an ortho-restorative treatment plan for moving the patient's teeth from the initial tooth arrangement toward the target tooth arrangement via a series of intermediate tooth arrangements, wherein the target tooth arrangement includes a change in mass of at least one tooth of the patient's teeth associated with a restorative feature, wherein generating the ortho-restorative treatment plan includes optimizing a relative position of a restorative feature model and a tooth model of the at least one tooth in the target tooth arrangement to minimize a tooth mass loss of the at least one tooth associated with the restorative feature; and
generating instructions to output a visualization showing the tooth mass loss of the at least one tooth associated with the restorative feature.

2. The computer-implemented method of claim 1, wherein the ortho-restorative treatment plan includes multiple restorative features, wherein generating the ortho-restorative treatment plan includes optimizing relative positions of multiple restorative feature models and the tooth model of the at least one tooth.

3. The computer-implemented method of claim 1, wherein generating the ortho-restorative treatment plan further includes optimizing a size of the restorative feature model relative to the tooth model of the at least one tooth to minimize the tooth mass loss of the at least one tooth associated with the restorative feature.

4. The computer-implemented method of claim 1, wherein minimizing the tooth mass loss is one of multiple clinical and/or aesthetic goals that are optimized, wherein the multiple clinical and/or aesthetic goals further includes one or more of:
minimizing a tooth mass loss of specific one or more teeth of the patient's teeth;
minimizing a duration of the ortho-restorative treatment plan;
minimizing breaching of dentin of the one or more teeth;
minimizing a number of dental attachments used in the ortho-restorative treatment plan;
achieving a desired smile line;
achieving a desired amount of the patient's gums showing in a smile;
achieving a desired height of a bite of the patient's teeth;
achieving a maximum orthodontic grade;
minimizing a discrepancy between a centric occlusion (CO) and/or a centric relation (CR) of the patient's mandible;
achieving a desired amount of bite contact;
achieving a desired amount of vertical force between the patient's upper and lower jaws;
considering the presence of one or more implants;
considering a material of the restorative feature;
considering different materials of the restorative feature on different teeth of patient;
considering the use of a pre-less restorative feature;
achieving a stable arch of the patient;
generating enough bone for an implant;
considering a position of one or more nerves;
maximizing gingival preservation;
considering any discrepancies between the patient's upper and lower arches.

5. The computer-implemented method of claim 1, wherein optimizing the relative position of the restorative feature model and the tooth model of the at least one tooth comprises:
identifying a portion of the tooth model of the at least one tooth that resides outside of the restorative feature model;
determining a volume of the portion of the tooth model of the at least one tooth that resides outside of the restorative feature model, wherein the volume corresponds to a volume of the tooth mass loss; and
iteratively adjusting a position the restorative feature model and/or the tooth model until the volume is minimized.

6. The computer-implemented method of claim 5, wherein the position the restorative feature model and/or the tooth model are iteratively adjusted based on a penalty function.

7. The computer-implemented method of claim 1, wherein the tooth model is represented by a plurality of tooth points that is less than a plurality of points defining an entire mesh of the tooth model.

8. The computer-implemented method of claim 7, wherein locations of the plurality of tooth points on the tooth model are based on an intended location of the restorative feature model on the tooth model.

9. The computer-implemented method of claim 7, wherein minimizing the tooth mass loss includes:
determining a shape overlap value between the restorative feature model and the tooth model, wherein the shape overlap value is a squared distance between the plurality of tooth points and the restorative feature model; and
adjusting the relative position so that the shape overlap value tends to zero.

10. The computer-implemented method of claim 1, wherein the restorative feature model is represented by a plurality of restorative points, wherein the plurality of restorative points are determined by decimating a mesh of the restorative feature model and identifying center points of each polygon of the decimated mesh, wherein the plurality of restorative points corresponds to the center points of the polygons of decimated mesh.

11. The computer-implemented method of claim 10, further comprising
assigning weights to the plurality of restorative points;
calculating distances between the plurality of restorative points and the tooth model;
penalizing each restorative point of the plurality of restorative points that is inside the tooth model; and
calculating a weighted sum of the penalized restorative points.

12. The computer-implemented method of claim 1, wherein at least one intermediate tooth arrangement of the series of intermediate tooth arrangements includes an intermediate restorative feature model, wherein generating the ortho-restorative treatment plan further includes optimizing a relative position of the intermediate restorative feature model and a tooth model in the at least one intermediate tooth arrangement.

13. The computer-implemented method of claim 1, wherein optimizing the relative position of the restorative feature model and the tooth model of the at least one tooth includes moving the restorative feature model and/or moving the tooth model.

14. The computer-implemented method of claim 1, wherein the visualization includes an overlap view showing an overlap of the restorative feature model and the tooth model indicating a location of the tooth loss mass.

15. A system for ortho-restorative treatment planning, the system comprising:
one or more processors; and
one or more memory stores coupled to one or more processors, the one or more memory stores configured to store computer instructions that, when executed by the one or more processors, perform a computer-implemented method comprising:
accessing an initial tooth model representing an initial tooth arrangement of a patient's teeth;
generating an ortho-restorative treatment plan for moving the patient's teeth from the initial tooth arrangement toward the target tooth arrangement via a series of intermediate tooth arrangements, wherein the target tooth arrangement includes a change in mass of at least one tooth of the patient's teeth associated with a restorative feature, wherein generating the ortho-restorative treatment plan includes optimizing a relative position of a restorative feature model and a tooth model of the at least one tooth in the target tooth arrangement to minimize a tooth mass loss of the at least one tooth associated with the restorative feature; and
generating instructions to output a visualization showing the tooth mass loss of the at least one tooth associated with the restorative feature.

16. The system of claim 15, wherein generating the ortho-restorative treatment plan further includes optimizing a size of the restorative feature model relative to the tooth model of the at least one tooth to minimize the tooth mass loss of the at least one tooth associated with the restorative feature.

17. The system of claim 15, wherein the tooth model is represented by a plurality of tooth points that is less than a plurality of points defining an entire mesh of the tooth model.

18. The system of claim 15, wherein the restorative feature model is represented by a plurality of restorative points, wherein the plurality of restorative points are determined by decimating a mesh of the restorative feature model and identifying center points of each polygon of the decimated mesh, wherein the plurality of restorative points corresponds to the center points of the polygons of decimated mesh.

19. A computer system configured to generate a user interface, wherein the user interface is configured to:
display aspects of an ortho-restorative treatment plan for moving a patient's teeth from an initial tooth arrangement toward a target tooth arrangement via a series of intermediate tooth arrangements, wherein the target tooth arrangement includes a change in mass of at least one tooth of the patient's teeth associated with a restorative feature; and
display an overlap view of a restorative feature model and a tooth model of the at least one tooth in the target tooth arrangement, wherein the restorative feature model has an optimized position relative to the tooth model that minimizes a tooth mass loss of the at least one tooth associated with the restorative feature.

20. The computer system of claim 19, wherein the user interface is further configured to provide one or more controls that allow the user to adjust the optimized position of the restorative feature.
